(19) United States
(12) Patent Application Publication
(10) Pub. No.: US 2021/0274950 A1
(43) Pub. Date: Sep. 9, 2021

(54) YAYDA BLANKET

(71) Applicant: Harry L. Wilson, JR., Spencer, OK (US)

(72) Inventor: Harry L. Wilson, JR., Spencer, OK (US)

(21) Appl. No.: 17/130,381

(22) Filed: Dec. 22, 2020

Related U.S. Application Data
(60) Provisional application No. 62/985,283, filed on Mar. 4, 2020.

(51) Int. Cl. A47G 9/02; B32B 5/26

(52) U.S. Cl. CPC A47G 9/023; A47G 9/0223; B32B 5/26

(57) ABSTRACT

A secure bed covering having an attached foot pocket according to the present invention is disclosed. A blanket having a front or outer side and a back or inner side may include a foot pocket running the width of the back or inner side. The foot pocket may be located at a distance from one end of the blanket such that when it is placed onto a bed, a user may insert his or her feet into the foot pocket and have the main part of the blanket cover the remaining parts of his or her body. By inserting their feet into the foot pocket, the user will keep their feet covered and warm as well as provide an anchoring force to prevent a partner from uncovering the feet should they move during the night. The foot pocket may be made of or lined by a different material that the main part of the blanket to provide additional comfort to users' feet.

### CROSS-REFERENCE TO RELATED APPLICATION

This application claims priority to U.S. Patent Application No. 62/985,283, titled “YAYDA BLANKET,” and filed on Mar. 4, 2020. The entire application is incorporated herein by reference in its entirety.

### TECHNICAL FIELD

This application relates in general to an article of manufacture for providing a blanket and bed covering, and more particularly, a blanket for a bed having an attached pocket to keep someone's feet warm.

### BACKGROUND

People experience difficulty staying warm in bed and keeping their feet covered by blankets, especially when sharing a bed with a partner. Movement of one partner affects how the blankets are arranged to keep everyone's feet covered and warm. Keeping one's feet covered can become an ongoing and never ending task.

The present invention attempts to address the existing problem of securing a bed covering for all individuals in a bed according to the principles and example embodiments disclosed herein.

### SUMMARY

In accordance with the present invention, the above and other problems are solved by providing an article of manufacture consisting of a bed covering with an attached foot pocket. The Yayda Blanket is designed to keep your feet completely covered as you sleep or relax in your bed. With a foot pocket on the inside of the blanket that will not allow your feet to be exposed to cold air doing rough or sleepless nights. The Yayda Blanket is not just for one person, no its designed for as many people that can fit on your bed. With a wool insert in the foot pocket to keep your feet warm and or a silk/satin insert to help with sweaty feet syndrome. The Yayda Blanket will come in sizes ranging from Twin to California King, plus there will be an extra foot of material added to the Yayda Blanket so that you will not lose any blanket material on your chest while using the foot pocket of the Yayda Blanket. The foot pocket for the Yayda Blanket itself will be (2′) two feet deep so no matter how tall you are your feet will be in the comforts of the Yayda Blanket. The Yayda Blanket will come with options such as (sewed in/fixed, button down the side and or zippers on the side for washer machine use) plus removable inserts.

One aspect of the present disclosure, a bed covering includes a fabric covering material having a front side and a back side, the back side having a top edge, a bottom edge and a width, and a removable foot pocket attached to the back side positioned about a bottom edge across a portion of a width of the back side and having a small portion of the blanket extending below the foot pocket enabling the small portion to be tucked under the mattress, the removable foot pocket being configured to attach to the back side of the covering material a various positions between the bottom edge and the top edge of the back side. The back side further comprises a main back side segment from a top edge of the foot pocket to a top edge of the back side.

In another aspect of the present disclosure, the removable foot pocket is made of a different material from the fabric covering material.

In another aspect of the present disclosure, the removable foot pocket attaches to the back side of the covering material using an attachment mechanism, the attachment mechanism comprises a set of zippers, a series of mating buttons and buttonholes, a series of mating snaps, a series of mating hooks, and a set of Velcro™ strips.

In another aspect of the present disclosure, the removable foot pocket comprises an inner side that is oriented towards the fabric covering material and a soft inner liner layer comprising satin, silk, and cotton.

In another aspect of the present disclosure, the fabric covering material has a size corresponding to one of the following bed sizes: twin, full, queen, king, and California king.

In another aspect of the present disclosure, the bed covering further comprises a second removable foot pocket, the foot pocket and the second foot pocket each covering a portion of half of the width of the back side and the foot pocket and the second foot pocket being configured to attach to the back side a different distances between the top edge and the bottom edge.

In another aspect of the present disclosure, the foot pocket and the second foot pocket are attached to the back side along a bottom side, a left side, and a right side and a top side of the foot pocket being oriented towards the top edge of the back side when attached to the back side.

In another aspect of the present disclosure, the fabric covering material comprises wool, polyester, cotton, fleece, and synthetic materials having a thickness greater than the foot pocket.

In another aspect of the present disclosure, the bed covering further includes an attachment strip running from the top edge to the bottom edge of the bed covering about a middle of the front side and a pair of removable blanket inserts attachable to each of half of the front side using attachment mechanisms on the inserts and the front side of the fabric covering material.

In another aspect of the present disclosure, the removable blanket inserts comprise the same and different thicknesses.

In another aspect of the present disclosure, the bed covering includes a fabric covering material having a front side and a back side, the back side having a top edge, a bottom edge and a width and a foot pocket stitched to the back side positioned about a bottom edge across a portion of a width of the back side and having a small portion of the blanket extending below the foot pocket enabling the small portion to be tucked under the mattress. The back side further comprises a main back side segment from a top edge of the foot pocket to a top edge of the back side.

In another aspect of the present disclosure, the removable foot pocket is made of a different material from the fabric covering material, and the foot pocket comprises an inner side that is oriented towards the fabric covering material; and a soft inner liner layer comprising satin, silk, and cotton.

In another aspect of the present disclosure, the fabric covering material has a size corresponding to one of the following bed sizes: twin, full, queen, king, and California king; and the fabric covering material comprises wool, polyester, cotton, fleece, and synthetic materials having a thickness greater than the foot pocket.

In another aspect of the present disclosure, the bed covering further comprises a second foot pocket stitched to the back side of the fabric covering material, the foot pocket and the second foot pocket each covering a portion of half of the width of the back side. The foot pocket and the second foot pocket being configured to attach to the back side a different distances between the top edge and the bottom edge. A top side of the foot pocket being oriented towards the top edge of the back side when attached to the back side.

In another aspect of the present disclosure, the bed covering further includes an attachment strip running from the top edge to the bottom edge of the bed covering about a middle of the front side and a pair of removable blanket inserts attachable to each of half of the front side using attachment mechanisms on the inserts and the front side of the fabric covering material. The removable blanket inserts comprise the same and different thicknesses.

The great utility of the invention is that a bed covering with a foot pocket will remain secure for everyone using the blanket. The problem the Yayda Blanket solves results in no need to wear socks to bed. No more waking up with cold feet because a person or their partner has pulled the blanket off while sleeping. Especially if the person is elderly and is cold all the time. They can enjoy the Yayda Blanket while lying in bed. Partners do not have to put their feet inside the foot pocket of the Yayda Blanket. As a result, everybody remains happy.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate a front side and a back side of one potential embodiment an article of manufacture for providing a secure bed covering having an attached foot pocket according to the present invention.

FIG. 2 illustrates a side view of an example embodiment an article of manufacture for providing a secure bed covering having an attached foot pocket according to the present invention.

FIGS. 3a-d illustrate example embodiments for various detachable foot pockets of a secure bed covering having an attached foot pocket according to the present invention.

FIGS. 4a-b illustrate another example embodiments for an article of manufacture for providing a secure bed covering having various detachable foot pockets and blanket sides according to the present invention.

### DETAILED DESCRIPTION

This application relates in general a secure bed covering having an attached foot pocket according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “sleeper” refers to an entity, e.g. a human, that uses a secure bed covering having an attached foot pocket according to the present invention in order to bring about a desired effect or outcome, particularly provide the user an ability to keep their feet warm at night. For such a user, the terms “user” and “sleeper” may be used herein interchangeably.

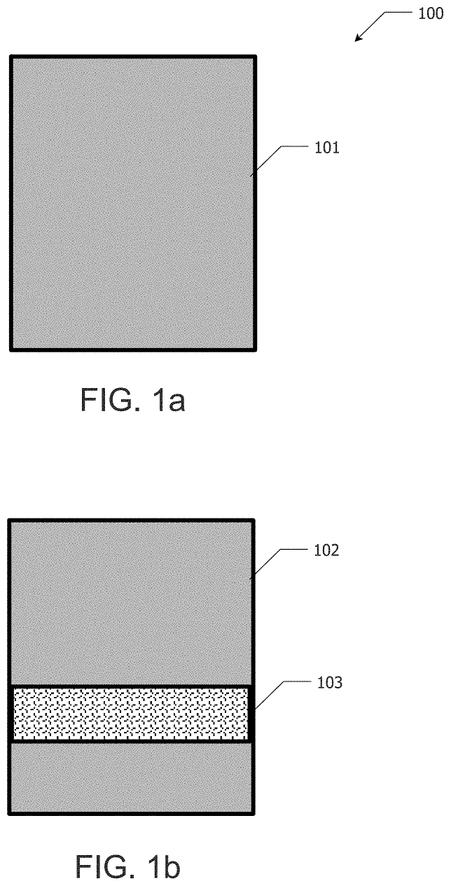

In general, the present disclosure relates general a secure bed covering having an attached foot pocket according to the present invention. To better understand the present invention, FIGS. 1a-b illustrate a front side and a back side of one potential embodiment an article of manufacture for providing a secure bed covering having an attached foot pocket according to the present invention. In a preferred embodiment of FIG. 1a, a secure bed covering 100 may consist of a wool blanket 101 having a plain front or outside side. The wool blanket 101 may be sized to fit any bed from twin size to California king as well as all standard sizes in between. The wool blanket may also be made of other fabrics useful to keep people warm while in bed.

FIG. 1b illustrates a back side or an inner side of a blanket 102. The back side contains a main back side segment 102 and an attached foot pocket 103 located towards one of the two ends. The foot pocket 103 runs across the entire width of the back side 102 allowing all individuals to place their feet within the foot pocket 103 if desired. The preferred embodiment shown in FIG. 1b shows the foot pocket 103 not at the very bottom of the back side 102 to permit a small portion of the blanket 100 to be tucked into the mattress while permitting the foot pocket 103 to remain on top of the bed for access by users. The exact location of the foot pocket 103 relative to the back side 102 of the blanket 100 may be set to different distances either when made or when configured by users to provide a location that best fits a user.

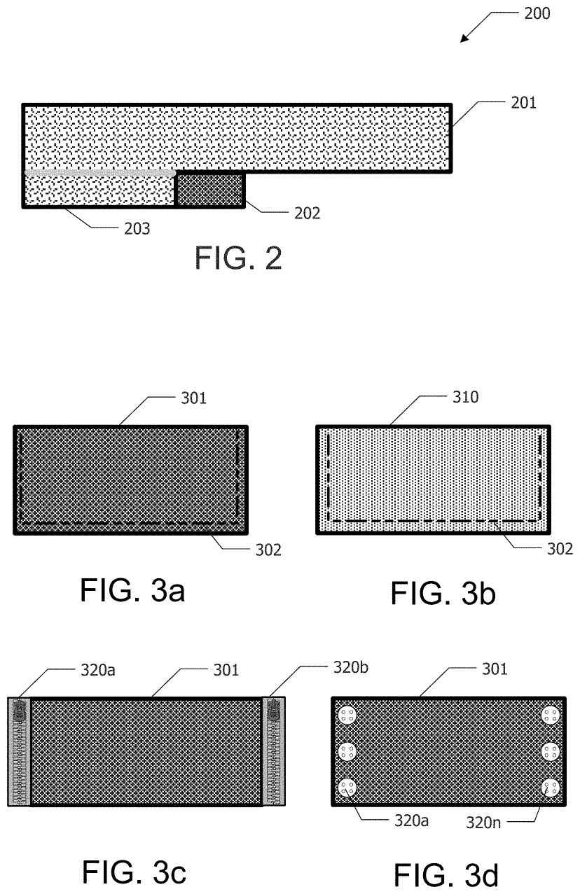

FIG. 2 illustrates a side view of an example embodiment an article of manufacture for providing a secure bed covering having an attached foot pocket according to the present invention. The blanket 200 is once again shown to be constructed using a main blanket layer 201 with an attached foot pocket 202 attached to the back side or inner side of the blanket. The foot pocket 202 is once again shown to be located at a desired distance for a bottom end of the blanket 200 such that a user may cover their entire body with the main part 201 of the blanket 200 while his or her feet are within the foot pocket 202. Once again, the main blanket layer may be made of a material useful to keep users warm, such a wool or cotton. An additional permanent layer of blanket material 203 over some or all parts of the blanket 200. This additional permanent layer of blanket material 203 may be located below the foot pocket 202, behind the foot pocket 202, above the foot pocket 202, and located as part of the entire blanket 200. The length of the blanket 200 may also be sized to fit a particular bed size where the users expect to utilize the blanket.

FIGS. 3a-d illustrate example embodiments for various detachable foot pockets of a secure bed covering having an attached foot pocket according to the present invention. Each of the different embodiments of foot pockets of FIGS. 3a-d represent foot pockets made from different materials and that are attached to the main blanket 200 on the back side 202 in different ways. FIG. 3a illustrate a foot pocket 301 made of the same material as the main part 201 of the blanket 200. In this example embodiment, the foot pocket 301 is attached to the blanket 200 using stitching 302 around three sides of the foot pocket 301. A top side of the foot pocket 301 is open to create a space forming a pocket into which users may place their feet while in bed. Users may choose to use the foot pocket if desired as the blanket 200 may also be used without use of the foot pocket 301.

FIG. 3b illustrates another embodiment of a foot pocket in which the foot pocket is made from a different material that the main part 201 of blanket 200. In this example, the main part 201 may be made of wool in which the foot pocket 310 is made of a different material such as satin, linen, or cotton. The choice of a different material of for the foot pocket 310 may be made to provide a level of comfort to user's feet when inserted into the foot pocket. In yet another embodiment. the inner side of the foot pocket 310 may be lined on both sides of the foot pocket if the users do not want to place their feet within a pocket made of the main blanket material. For example, a soft satin lining may feel better to a user's feet when compared to a rough wool material used to keep the user warm.

FIGS. 3c-3d illustrate different mechanisms to attach the foot pocket 301 to the main part 201 of blanket 200. FIG. 3c shows the foot pocket 301 attaching to the main part 201 of blanket 200 using a zipper 320a-b on each side of the foot pocket. Similarly, FIG. 3d shows a foot pocket 301 attached to blanket 200 using a series of buttons 330a-n down the two sides of the foot pocket. The zipper 320a-b and the buttons 330a-n may also be located along the bottom side of the foot pocket 301 to enclose three of the four sides as shown in FIGS. 3a-b. Additionally, other attachment mechanisms such as snaps, hooks, and Velcro™ may be used to attach the foot pocket 301 to the main part 201 of blanket 200. Of course, all of the above attachment mechanisms used with a detachable foot pocket 301 may be used on foot pockets of any material. Finally, these attachment mechanisms may permit the foot pocket 301 to be located at different distances from one end of the blanket 200. For example, a pair of rows of buttons or snaps may be located down both sides of the back side or inner side 102 of the blanket 100. If there are more snaps on the back side 102 of the blanket 100 that on the sides of foot pocket 301, the user may locate the foot pocket 301 at any location by using a set of snaps at the desired distance from the bottom end. Similar arrangements may be made with multiple zippers located down the sides of the back side 102 of blanket 100 or Velcro™ running the length of the sides of blanket 100.

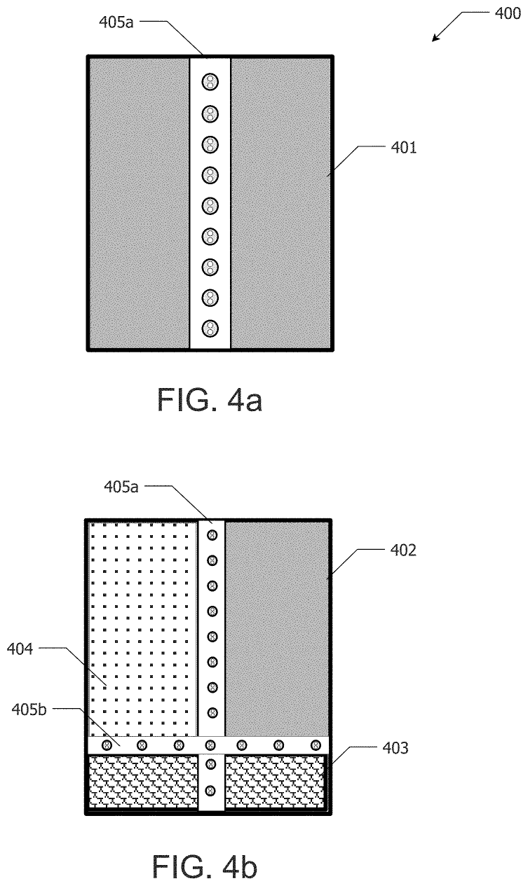

FIGS. 4a-b illustrate another example embodiments for an article of manufacture for providing a secure bed covering having various detachable foot pockets and blanket sides according to the present invention. This embodiment of a Yada blanket 400 has a front or outer side 401 that includes an attachment strip 405a running lengthwise from top to bottom of the blanket. The attachment strip 405a permits an individual attachment or removal of a blanket layer 404a-b on each side of the Yayda blanket. The attachment strip 405a is shown to utilize a series of buttons along the attachment strip 405a to hold the various blanket layers to the main blanket 401. The back or inner side 402 of the Yayda blanket 400 includes an attachment strip 405a for each side as well as a separate attachment strip 405b for attaching and removing a foot pocket 403 from the Yayda blanket 400 as discussed above with respect to the other disclosed embodiments.

When a user and partner are laying in the bed together while using a Yayda blanket 400, the partner may use multiple blanket layers 404a as they stay cold year round while the user removes blanket layers 404b as he or she are warm year around. The full bodied Yayda Blanket 400 insert 404a-b may be easily detached on either side as desired. These individually configurable layers allow users and partners to individually be as warm as each is desired. Additionally, a user may remove just the body portion insert 404a of the Yayda Blanket 400 while leaving the foot pocket insert 403 as well as removing it all together. With a Queen and King size Yayda Blanket 400, users may also break down blankets into 2 to 4 individual blankets all with the capability of utilizing a Yayda Blanket foot pocket 403.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What it is that is claimed:

1. An article of manufacture for providing a blanket and bed covering, the bed covering comprising:
a fabric covering material having a front side and a back side, the back side having a top edge, a bottom edge and a width; and
a removable foot pocket attached to the back side positioned about a bottom edge across a portion of a width of the back side and having a small portion of the blanket extending below the foot pocket enabling the small portion to be tucked under the mattress, the removable foot pocket being configured to attach to the back side of the covering material a various positions between the bottom edge and the top edge of the back side;
wherein the back side further comprises a main back side segment from a top edge of the foot pocket to a top edge of the back side.

2. The bed covering according to claim 1, wherein the removable foot pocket attaches to the back side of the covering material using an attachment mechanism, the attachment mechanism comprises a set of zippers, a series of mating buttons and buttonholes, a series of mating snaps, a series of mating hooks, and a set of Velcro™0 strips.

3. The bed covering according to claim 2, wherein the removable foot pocket is made of a different material from the fabric covering material.

4. The bed covering according to claim 3, wherein the removable foot pocket comprises an inner side that is oriented towards the fabric covering material; and
a soft inner liner layer comprising satin, silk, and cotton.

5. The bed covering according to claim 4, wherein the fabric covering material has a size corresponding to one of the following bed sizes: twin, full, queen, king, and California king.

6. The bed covering according to claim 2, wherein the bed covering further comprises a second removable foot pocket, the foot pocket and the second foot pocket each covering a portion of half of the width of the back side; and
the foot pocket and the second foot pocket being configured to attach to the back side a different distances between the top edge and the bottom edge.

7. The bed covering according to claim 6, wherein the foot pocket and the second foot pocket are attached to the back side along a bottom side, a left side, and a right side; and
a top side of the foot pocket being oriented towards the top edge of the back side when attached to the back side.

8. The bed covering according to claim 1, wherein the fabric covering material comprises wool, polyester, cotton, fleece, and synthetic materials having a thickness greater than the foot pocket.

9. The bed covering according to claim 7, wherein the bed covering further comprises:
an attachment strip running from the top edge to the bottom edge of the bed covering about a middle of the front side; and
a pair of removable blanket inserts attachable to each of half of the front side using attachment mechanisms on the inserts and the front side of the fabric covering material.

10. The bed covering according to claim 8, wherein the removable blanket inserts comprise the same and different thicknesses.

11. An article of manufacture for providing a blanket and bed covering, the bed covering comprising:
a fabric covering material having a front side and a back side, the back side having a top edge, a bottom edge and a width; and
a foot pocket stitched to the back side positioned about a bottom edge across a portion of a width of the back side and having a small portion of the blanket extending below the foot pocket enabling the small portion to be tucked under the mattress;
wherein the back side further comprises a main back side segment from a top edge of the foot pocket to a top edge of the back side.

12. The bed covering according to claim 11, wherein the removable foot pocket is made of a different material from the fabric covering material; and
the foot pocket comprises:
an inner side that is oriented towards the fabric covering material; and
a soft inner liner layer comprising satin, silk, and cotton.

13. The bed covering according to claim 13, wherein
the fabric covering material has a size corresponding to one of the following bed sizes: twin, full, queen, king, and California king; and
the fabric covering material comprises wool, polyester, cotton, fleece, and synthetic materials having a thickness greater than the foot pocket.

14. The bed covering according to claim 1, wherein the bed covering further comprises a second foot pocket stitched to the back side of the fabric covering material, the foot pocket and the second foot pocket each covering a portion of half of the width of the back side;
the foot pocket and the second foot pocket being configured to attach to the back side a different distances between the top edge and the bottom edge;
the foot pocket and the second foot pocket are attached to the back side along a bottom side, a left side, and a right side of the foot pocket; and
a top side of the foot pocket being oriented towards the top edge of the back side when attached to the back side.

15. The bed covering according to claim 7, wherein the bed covering further comprises:
an attachment strip running from the top edge to the bottom edge of the bed covering about a middle of the front side; and
a pair of removable blanket inserts attachable to each of half of the front side using attachment mechanisms on the inserts and the front side of the fabric covering material;
wherein the removable blanket inserts comprise the same and different thicknesses.
